(19) United States
(12) Patent Application Publication
(10) Pub. No.: US 2008/0089994 A1
(43) Pub. Date: Apr. 17, 2008

(54) PROCESS FOR WHISKEY RECOVERY

(75) Inventors: William T. Effler, Mount Washington, KY (US); Charles Geisler, Louisville, KY (US); Denis Roth, Louisville, KY (US); Larry Combs, Flyods Knobs, IN (US)

Correspondence Address: MCDERMOTT WILL & EMERY LLP, 600 13TH STREET, N.W., WASHINGTON, DC, 20005-3096, US

(73) Assignee: BROWN-FORMAN CORPORATION

(21) Appl. No.: 11/751,301

(22) Filed: May 21, 2007

Related U.S. Application Data
(60) Provisional application No. 60/850,673, filed on Oct. 11, 2006.

(51) Int. Cl. C12G 3/00

(52) U.S. Cl. 426/592

(57) ABSTRACT

Whiskey absorbed in barrel wood is recovered from a recently drained whiskey barrel by adding 20-24 gallons of water to and holding the rinse water in the barrel for 20 or more days. Only a single rinse is required and no rolling or swishing of the barrel is necessary to extract the residual whiskey from the wood of the barrel.

### CROSS REFERENCE TO RELATED APPLICATION

This application claims the benefit of priority of Provisional Application No. 60/850,673, filed Oct. 11, 2006, which is incorporated herein by reference.

### FIELD OF INVENTION

The invention is directed to maximum recovery of whiskey in a barrel.

### BACKGROUND

After high proof whiskey is distilled, it is stored in wood barrels, for example barrels made of oak. The barrels are normally toasted and charred prior to being filled with whiskey. During storage, the toasted and charred wood adds color and flavor to the whiskey. After a period of time in storage in the barrel, typically 2 to 6 years, the high proof whiskey is drained from the barrel into a transfer line then pumped to a bulk storage tank from which the whiskey is then further diluted and bottled. It is known that the barrel does contain residual whiskey that has been absorbed into the wood.

The whiskey industry has traditionally used water to rinse the barrels of any residual whiskey after dumping. It was common to use 2 to 3 gallons of rinse water to the barrel. A temporary bung is placed in the bunghole and the barrels were rolled on an accumulation line for 3 to 5 minutes. The rinse water was drained from the barrel into the same transfer line as the high proof whiskey and went to bulk tank storage along with the high proof whiskey.

There is a technique known as “swishing” which is used by persons who buy old whiskey barrels. This technique encompasses adding a few gallons of water, for example about 3 gallons, to the barrel and rolling the barrel occasionally for at least 21 days or for a month. The water slowly desorbs the whiskey left in the wood. The rinse water when removed from the barrel could contain 35% to 40% alcohol.

There is a need for the industry to recover a maximum amount of whiskey as possible that is absorbed in the wood of the whiskey barrel without having to roll the barrel.

### SUMMARY OF THE INVENTION

An object of this invention is to provide for maximum recovery of whiskey from a wooden whiskey barrel after initial emptying of the barrel. This objective of this invention can be obtained by providing adding 20 to 24 gallons of water to a barrel and storing the barrel for 20 or more days without having to roll or “swish” the barrel. Other objects, features and advantages of this invention will become apparent upon reading the following detailed description and referring to the accompanying drawing.

### BRIEF DESCRIPTION OF THE DRAWING

FIG. 1 graphically illustrates the relationship between holding time and amount of Proof Gallons of whiskey extracted per barrel (PG/bbl).

FIG. 2 is a table summarizing the proof gallon recovery of whiskey based on the amount of rinse water and hold time for the rinse water in the barrel.

FIG. 3 is a table summarizing the mean proof gallon recovery for hold times of 14, 21 and 28 days for 8-10, 15 and 20 gallons of rinse water used.

### DETAILED DESCRIPTION OF THE INVENTION

The amount of residual whiskey desorbed by the enhanced whiskey recovery process after an effective initial barrel draining is on the average about 2.65 Proof Gallons per barrel (PG/bbl). Traditional rinsing recovers about an additional 0.3 PG/bbl. It has been discovered that whiskey recovery is dependent on rinse water volumes and that there is a linear relationship between rinse water volumes and whiskey recovery which has heretofore not been known in the prior art.

The extent of residual whiskey recovery is dependent on hold time. Residence time increases whiskey recovery but only up to a point beyond which excessive hold times are detrimental to proof gallon recovery. The rate of recovery is dependent on the elapsed hold time with recovery rates greatest during the initial phases and less during the later stages of the process. However, longer holding times do not negatively affect product quality and stability. The whiskey recovered during the longer term hold is suitable for including in the finished product. The rinse water is drained into the same transfer line as the high proof whiskey and is pumped to a bulk tank for storage along with the high proof whiskey.

The method of the invention comprises filling wooden barrels with whiskey. The barrels are typically made of oak. The barrels are stored for a period of time to add color and flavor and allow the whiskey to mellow. The barrels are then drained and filled with 20 to 24 gallons of rinse water. While the water could be normal tap water, it is preferable to use water prepared by a conventional reverse osmosis filtration process. This process essentially eliminates all solids from water and therefore increases the filtered water's ability to diffuse residual whiskey from the barrel wood. The barrels holding the rinse water are held in storage for 20 or more days. Preferably the time is from 21 to 36 days, with 21 or 22 days most preferred. There is no need to roll or “swish the barrels.” The rinse water containing the desorbed whiskey is emptied into the same line as high proof whiskey and send to a bulk storage tank.

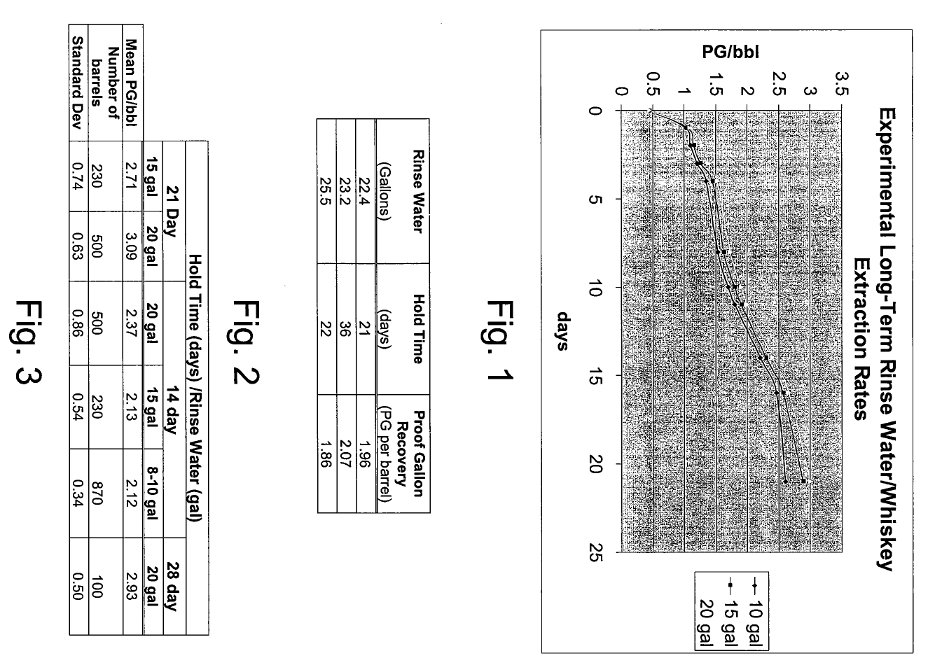

As shown in FIG. 1, whiskey recovery was optimized near 21 days. FIG. 2 shows that the longer the rinse water is held in the barrel, the proof gallon recovery is greater, but that the amount of rinse water above 24 gallons as well as the hold time does not affect the proof gallon recovery. FIG. 3 shows that greater recovery of whiskey occurs when more than 8-10 or 15 gallons of rinse water is used. In fact, the table in FIG. 3 shows that the amount of proof gallons recovered increases significantly when 20 gallons is used.

The following example describes the procedure for rinsing newly dumped whiskey barrels to maximize whiskey recovery through the use of specific rinse water volumes and temperatures. Whiskey barrels containing high proof whiskey are drained into a high proof dump line which empties into a high proof bulk whisky tank. In order to ensure all available high proof whiskey has been removed from the barrels, each barrel undergoes mechanical or visual inspection. About 20 to 24 gallons of reverse osmosis rinse water is added to each barrel. The temperature of the rinse water ranges from about 16° to about 25° C. A temporary bung is inserted into the bung hole of each barrel. The barrels are stored on pallets for a period of 21 to 36 days without rolling or swishing. The temperature in the facility is controlled and ranges from 21° C. to 35° C. At the end of the storage period, the rinse water is drained from the barrels and mixed with the whisky in the high proof bulk whisky tank.

While the form of the method of whiskey recovery has been described in accordance with the preferred embodiment of the invention, it is to be understood that changes may be made in the method without departing from the scope of the invention which is defined in the appended claims.

What is claimed is:

1. A method of recovery of residual whiskey from a wooden barrel comprising the steps of
emptying the whiskey from the barrel,
adding 20 to 24 gallons of rinse water to the barrel, and
holding the rinse water in the barrel for a holding period of at least 20 days without rolling or swishing the barrel to recover whiskey absorbed into the wood of the barrel.

2. The method of claim 1, wherein the barrel is an oak barrel.

3. The method of claim 1, wherein the rinse water is filtered by reverse osmosis.

4. The method of claim 1 comprising the further steps of emptying the whiskey into a bulk storage container and emptying the rinse water containing whiskey absorbed from the wood of the wooden barrel into the bulk storage container.

5. The method of claim 1, wherein the holding period is 21 to 36 days.

6. The method of claim 5, wherein the holding period is 21 days.

7. The method of claim 5, wherein the holding period is 36 days.

8. The method of claim 1, wherein the amount of rinse water is 20 gal.

9. The method of claim 5, wherein the amount of rinse water is 20 gal.

10. The method of claim 1, wherein the amount of rinse water is 24 gal.

11. The method of claim 5, wherein the amount of rinse water is 24 gal.

12. The method of claim 2, wherein the amount of rinse water is 24 gal. and the holding period is 21 days.
